(19) United States
(12) Patent Application Publication
(10) Pub. No.: US 2026/0057802 A1
(43) Pub. Date: Feb. 26, 2026

(54) EmpathiCode: AI Roleplay Empathy Training

(71) Applicant: Charlene N Win, Porter Ranch, CA (US)

(72) Inventor: Charlene N Win, Porter Ranch, CA (US)

(21) Appl. No.: 19/308,184

(22) Filed: Aug. 23, 2025

(51) Int. Cl. G09B 19/00; A63F 13/822

(52) U.S. Cl. CPC G09B 19/00; A63F 13/822; A63F 2300/807

(57) ABSTRACT

A computer-implemented method for empathy skill development using AI-driven interactive text adventures. Users specify a persona, scenario type, and empathy objectives, and the system generates branching narrative scenarios with multiple selectable options. Choices are made without hints, and the story unfolds naturally, showing outcomes and character reactions. After each scenario, the system provides delayed reflective prompts to guide consideration of consequences, character perspectives, and alternative strategies. Recurring user challenges are recorded, and future scenarios are adapted to reinforce weaker areas, enabling safe, immersive, and personalized empathy training across diverse narrative contexts.

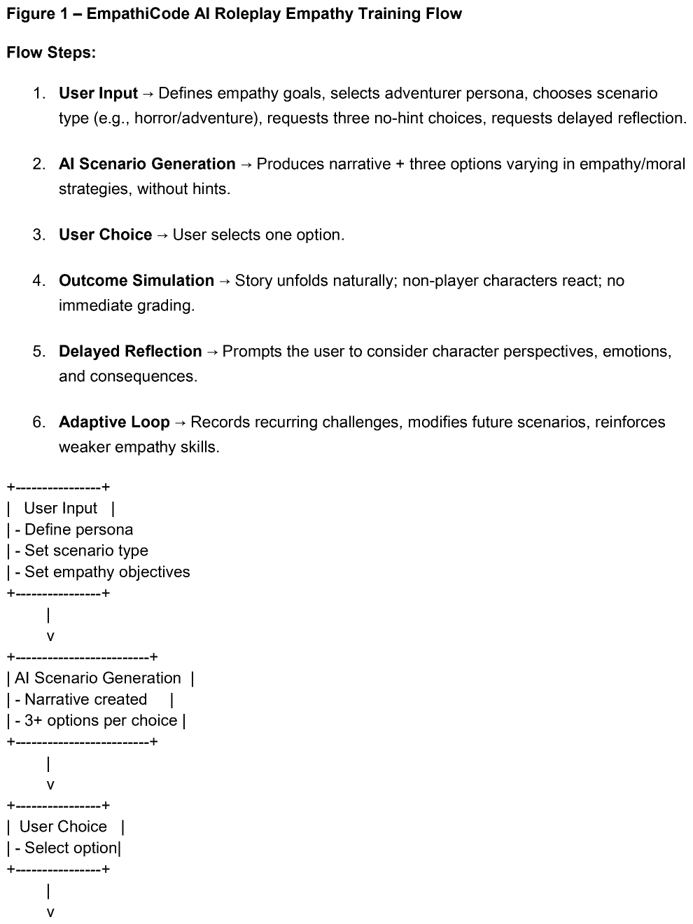

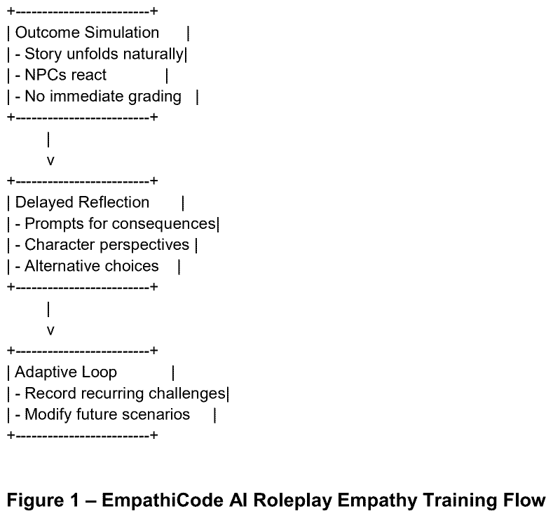

### 1. FIELD OF THE INVENTION

The present invention relates to artificial intelligence-implemented methods for empathy skill development, and more particularly to using AI-driven interactive text adventures to provide immersive, scenario-based experiences that allow users to safely explore emotions, perspective-taking, and interpersonal consequences.

### 2. BACKGROUND

Many individuals struggle to develop empathy due to trauma, antisocial tendencies, or reduced emotional responsiveness. Conventional training methods—lectures, direct instruction, or roleplay exercises—often fail to engage these users or allow safe exploration of emotionally or morally challenging scenarios.

There is a need for AI-driven methods that allow users to safely experience complex emotional and moral scenarios, experiment with choices, and internalize perspective-taking through delayed, guided reflection.

### 3. SUMMARY OF THE INVENTION

The invention provides a system in which a user engages in a text-based adventure powered by AI. Users make choices within immersive, often high-stakes scenarios (including text-adventure horror, conflict, or emotionally intense contexts), experience narrative consequences, and later receive prompts that encourage reflection and perspective-taking.

Key features include:
1. User-Defined Context: Users specify their adventurer persona, desired scenario types (e.g., text-adventure horror, survival, or morally challenging quests), and empathy development objectives.
2. AI Scenario Generation: The system generates branching narrative scenarios tailored to the user's persona and objectives. Each scenario presents three user-selectable options, including choices that demonstrate varying degrees of empathy, moral reasoning, or emotional insight.
3. Immersive Interaction: Users select an option, and the narrative proceeds naturally, showing the outcome of their choice in the scenario. Consequences appear through the reactions of non-player characters (NPCs) and story events, without immediate moral judgment or grading.
4. Delayed Reflective Feedback: After the scenario concludes, the system provides prompts encouraging users to reflect on:
   How their choices affected NPCS
   The emotions and perspectives of characters
   Alternative strategies that could have led to different outcomes
5. Safe Sandbox Exploration: The system allows users to safely explore emotionally intense or morally ambiguous scenarios—including scenarios involving “dangerous fantasies”—in a controlled, AI-mediated environment. This permits experimentation, emotional processing, and perspective-taking without risk of real-world harm.
6. Adaptive Loop: The system records recurring user challenges and adapts future scenarios to reinforce perspective-taking and emotional recognition in areas of difficulty. This method allows users to safely explore emotionally complex situations, engage fully with narrative stakes, and internalize empathy without the pressure of immediate evaluation.

### 4. EXAMPLE IMPLEMENTATION (METHODOLOGY-COMPLIANT)

A user may instruct the system:
“Let's play a text adventure. I want to practice understanding others'emotions and perspective-taking. Present three response options at each decision point, without indicating correctness. Let the story unfold naturally based on my choice, and provide reflective prompts only after each scenario concludes. I want to be an adventurer in a tense, horror-survival setting.”

At each decision point:
The user is presented with three options reflecting different empathy-driven or emotionally aware strategies.
The story continues based on the selected choice, showing outcomes and NPC reactions naturally, without immediate feedback or moral labeling.
After the scenario, the system prompts reflection on consequences, character feelings, and alternative choices.
Subsequent scenarios adapt to reinforce weaker areas in empathy and perspective-taking.

### 5. ADVANTAGES

Enables experiential empathy learning in immersive, narrative contexts.
Prevents over-reliance on external judgment or immediate feedback.
Provides safe exploration of emotionally or morally challenging scenarios.
Supports adaptive, personalized learning based on user performance.
Engages users resistant to traditional empathy training methods.

1. An AI-implemented method for empathy skill development, comprising:
receiving, from a user, an instruction to initiate a text-based adventure for empathy or perspective-taking;
generating, by an artificial intelligence system, a narrative scenario and at least three user-selectable response options per scenario;
presenting the options without providing hints or indications of correctness;
receiving a user selection;
simulating the outcome of the selected choice within the narrative, including reactions of simulated participants; and
after the scenario concludes, providing delayed reflective prompts encouraging the user to consider:
the consequences of their actions,
the perspectives and emotions of characters, and
alternative choices that could have led to different outcomes.

2. The method of claim 1, wherein the AI generates options with varying levels of empathy or moral reasoning, requiring the user to select without external cues.

3. The method of claim 1, wherein delayed reflection is provided only after the scenario has fully played out, separating immersive gameplay from guided learning.

4. The method of claim 1, further comprising recording recurring user challenges and modifying subsequent scenarios to provide targeted practice in perspective-taking and emotional recognition.

5. The method of claim 1, wherein the user defines the narrative setting, including text-adventure horror, survival, or emotionally intense adventure contexts.

6. The method of claim 1, wherein reflective prompts encourage the user to actively draw insights from the scenario rather than receive direct instruction.

7. The method of claim 1, wherein the system provides a safe sandbox environment for exploration of emotionally intense, morally ambiguous, or psychologically challenging scenarios, allowing experimentation without real-world risk.
